(19) United States
(12) Patent Application Publication
(10) Pub. No.: US 2017/0098383 A1
(43) Pub. Date: Apr. 6, 2017

(54) HANDWRITING WORKSHEET

(71) Applicant: Chan Wang BOHACHEFF, Charlotte, NC (US)

(72) Inventor: Chan Wang BOHACHEFF, Charlotte, NC (US)

(21) Appl. No.: 15/018,392

(22) Filed: Feb. 8, 2016

Related U.S. Application Data
(60) Provisional application No. 62/235,733, filed on Oct. 1, 2015.

(51) Int. Cl. G09B 11/04

(52) U.S. Cl. CPC G09B 11/04

(57) ABSTRACT

An aid for practicing handwriting is described herein. In some embodiments, the handwriting aid comprises a medium having one or more writing bands marked thereon, a writing band including horizontal lines defining adjacent rows. Columns divide the adjacent rows into blocks in which letters or portions thereof are to be written, wherein the columns have width less than width of the blocks and provide spacing between the letters. The blocks can have uniform width and height for consistent letter size.

### RELATED APPLICATION DATA

The present invention claims priority pursuant to 35 U.S.C. §119(e) to U.S. Provisional Patent Application Ser. No. 62/235,733 filed Oct. 1, 2015 which is incorporated herein by reference in its entirety.

### FIELD

The present invention relates to learning aids and, in particular, to worksheets for practicing and improving various handwriting techniques.

### BACKGROUND

Handwriting is often a difficult task for children to master. For example, learning to write neatly and within set boundaries can be complex for young children. Such complexity introduces frustration and anxiety into the handwriting learning process. In view of these difficulties, a variety of handwriting tools and aids have been developed. A handwriting tool widely employed consists of paper printed with parallel guide lines providing spaces in which to write. Pairs of the guidelines are commonly divided into equal upper and lower sections by a dashed divider line. The upper and lower sections delineate regions for upper case and lower case letter formation. While having some utility, aids of this design generally fail to teach children proper handwriting and much of the learning is lost as children transition to ruled notebook paper.

### SUMMARY

In view of these problems, handwriting aids are described herein having design and technical features for teaching accurate letter positioning and substantially uniform spacing. For example, an aid for practicing handwriting described herein comprises a medium having one or more writing bands marked thereon, a writing band including four horizontal lines defining three adjacent rows. Columns divide the three adjacent rows into blocks in which letters or portions thereof are to be written, wherein the columns have width less than width of the blocks and provide spacing between individual letters. The blocks can have uniform width and height for consistent letter size. Moreover, the center row can have shading or texture different than the adjacent top and bottom rows to delineate proper positioning of lower case letters. In some embodiments, the medium of the handwriting aid comprises paper, plastic, glass or an electronic medium or various combinations thereof.

In some embodiments, a writing band includes less than four horizontal lines or more than four horizontal lines. For example, a writing band can be limited to three horizontal lines defining two adjacent rows or two horizontal lines defining a single row. In such embodiments, columns divide the two adjacent rows or single row into blocks in which letters or portions thereof are to be written, wherein the columns have width less than width of the blocks.

These and other embodiments are described in greater detail in the following detailed description.

### BRIEF DESCRIPTION OF THE DRAWINGS

FIG. 1 illustrates a plan view of an aid for practicing handwriting according to some embodiments described herein.

FIG. 2 illustrates various functional aspects of an aid for practicing handwriting according to some embodiments described herein.

FIG. 3 illustrates letter, number and sentence writing using a handwriting aid according to some embodiments described herein.

FIG. 4 illustrates a plan view of an aid for practicing handwriting according to some embodiments described herein.

FIG. 5 illustrates a plan view of an aid for practicing handwriting according to some embodiments described herein.

FIG. 6 illustrates a plan view of an aid for practicing handwriting according to some embodiments described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

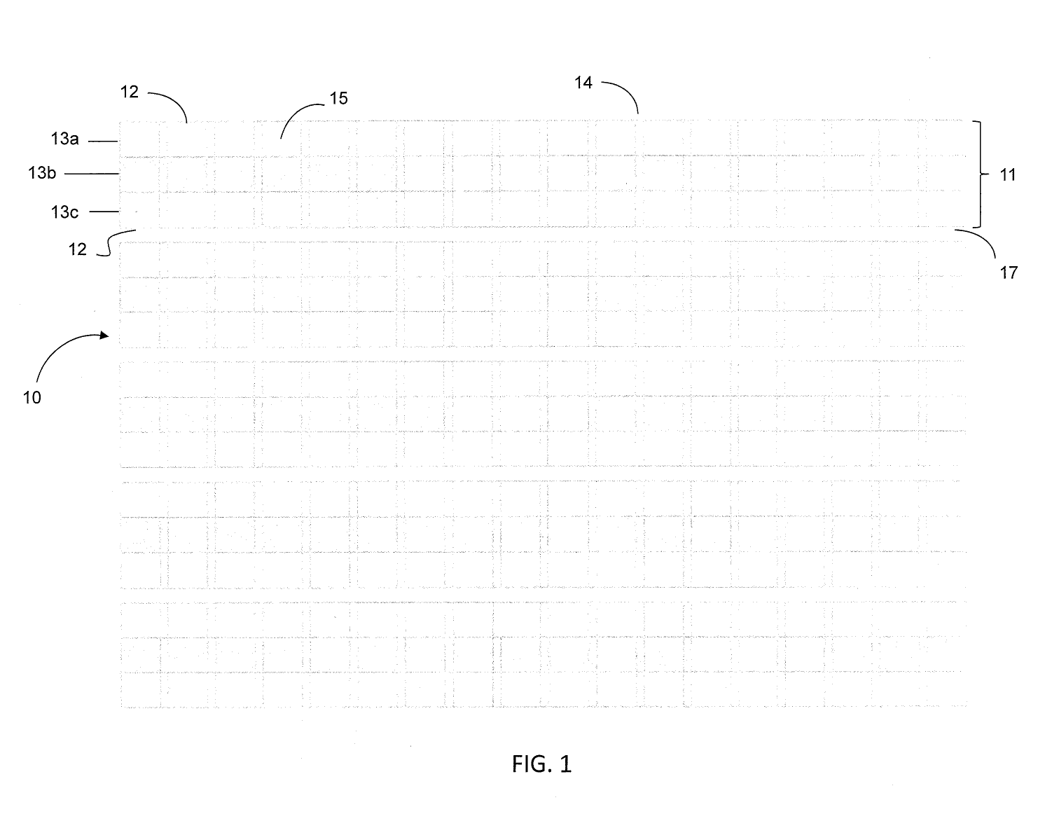

Referring to the embodiment of FIG. 1, an aid 10 for practicing handwriting comprises a medium having plurality of writing bands 11 marked thereon. Any medium not inconsistent with the objectives of the present invention can be employed. For example, the writing bands 11 can be marked on paper, plastic, glass, metal or various combinations thereof. Moreover, the medium can be an electronic medium such as that associated with a computer, tablet or smartphone. Suitable stylus apparatus can be used for handwriting when the aid is in electronic format. Non-writing space 17 is positioned between the writing bands 11. Each writing band comprises four horizontal lines 12 defining three adjacent rows 13, a top row 13a, center row 13b and bottom row 13c. Columns 14 divide the three adjacent rows 13 into blocks 15 in which letters, numbers or portions thereof are to be written. As illustrated in FIG. 1, the columns 14 have width less than the width of the blocks 15. Importantly, width of the columns 14 is sufficient to provide proper spacing between individual letters. For example, column 14 width can generally be 10 percent to 70 percent of block width. In some embodiments, column 14 width is has a value selected from Table I.

TABLE I
Column Width
Percent of Block Width
15-60
20-50
25-50
30-40
15-35
20-40

Column width also provides users of the handwriting aid a substantial visual cue that is easily contrasted with the letter blocks 15. Such a visual cue assist users in maintaining proper letter spacing when transitioning to traditional ruled notebook paper and marks a fundamental departure from prior writing aids that merely provide a grid of adjacent blocks or slots for letters with no separate visual cues related to letter spacing. In the embodiment of FIG. 1, the columns 14 have uniform width. However, it is contemplated that the columns 14 may have non-uniform width. For example, column width can be tailored to specific function. In some embodiments, a first set of columns have a first width for proper letter spacing, and a second set of columns have a second width for sentence spacing. Further, the columns 14 can be shaded, partially shaded or unshaded. Moreover, lines delineating the columns 14 can be solid or dashed. When in dashed format, the column lines can serve as guidelines or tracing lines for students to practice straight vertical line formation.

The columns 14 can have uniform spacing along the band 11 to provide blocks 15 of uniform width. Similarly, the horizontal lines 12 can have uniform spacing providing the blocks 15 uniform height. When in use, the body of a lower case letter can be written into the block 15 of the center row 13b. For a lower case letter having an ascender such as b, d, f, h, k, 1 and t, the ascender can extend into the adjacent vertical block 15 of the top row 13a. For a lower case letter having a descender such as g, j, p and q, the descender can extend into the adjacent vertical block of the bottom row 13c. Moreover, blocks 15 of the center row 13b and adjacent top row 13a provide space in which an upper case letter is written.

In some embodiments, a writing band 11 can include visual cues at the beginning and/or end of the writing band 11 to mark start and finish points for the user.

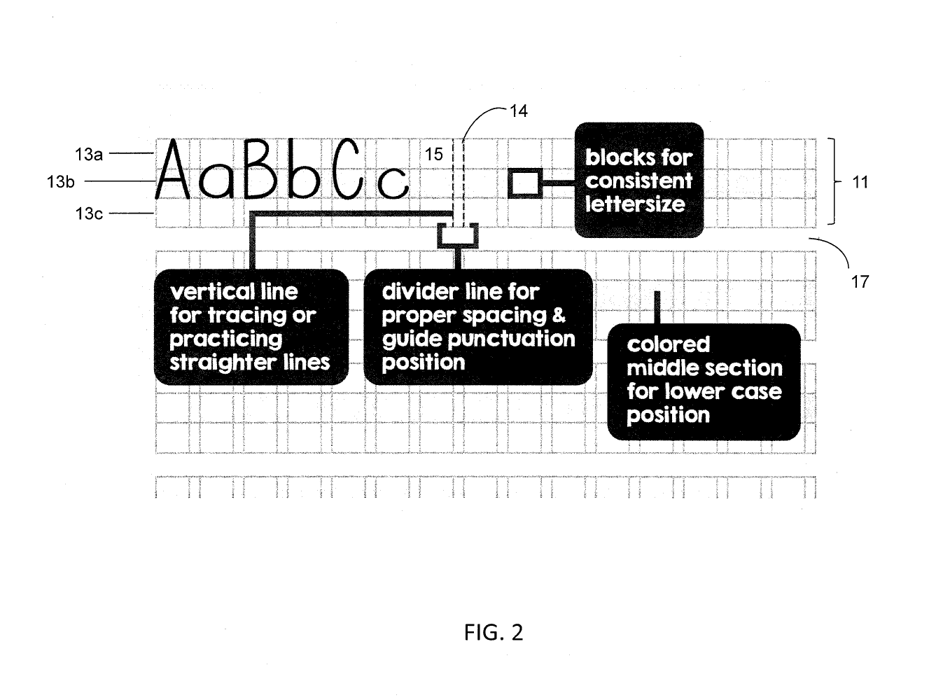

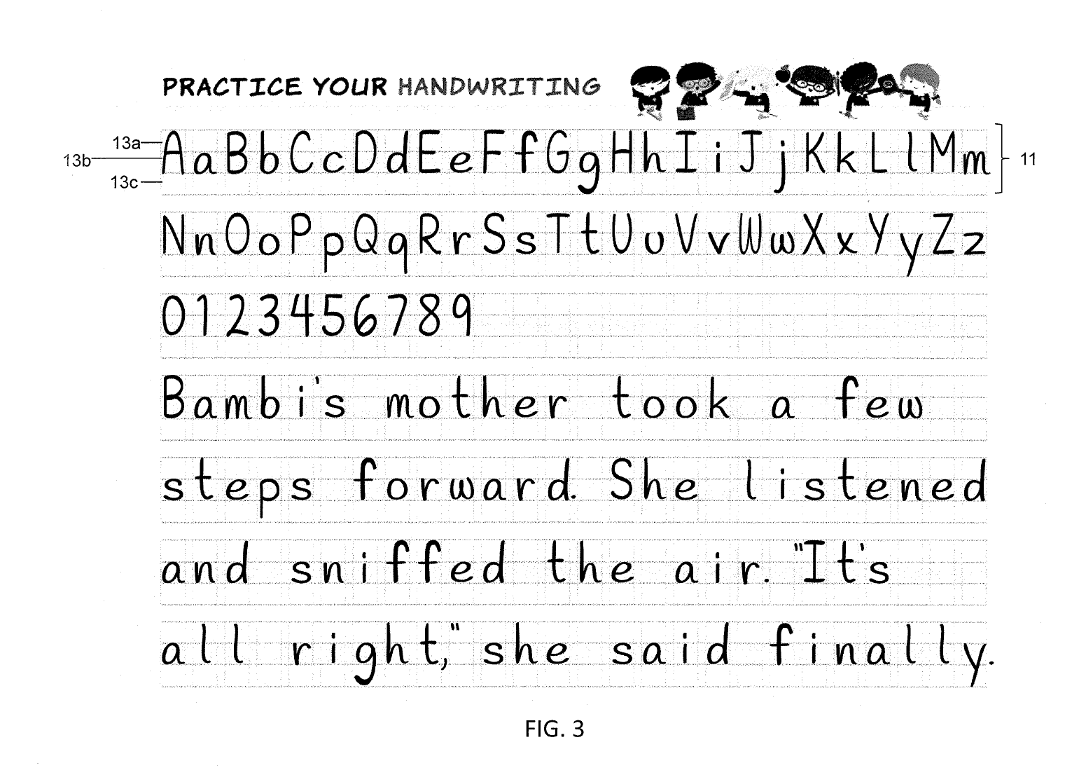

FIG. 2 illustrates the foregoing principles and technical aspects of the aid for practicing handwriting. As illustrated in FIG. 2, vertically adjacent blocks 15 of the center row 13b and upper row 13a accommodate upper case letters A, B and C. Lower case letters “a” and “c” individually fit within a single box 15 of the center row 13b. The body of lower case letter “b” also fits within a single box 15 of the center row 13b with the ascender extending into the vertically adjacent box 15 of the top row 13a. As in FIG. 1, the center row 13b is shaded or textured differently than the top row 13a and bottom row 13c. This different shading, texture or highlighting can indicate proper lower case letter positioning for a user of the handwriting aid. In the embodiment of FIGS. 1 and 2, the top row 13a and bottom row 13c are not shaded, textured or highlighted. However, in other embodiments, the top row 13a and/or bottom row may be shaded, textured or highlighted. For example, the top row 13a can be assigned shading, texture or highlighting indicating to a user that ascenders and/or upper portions of capital letters should extend into boxes 15 of the top row 13a. The bottom row 13c may also have shading, texturing or highlighting indicting descenders should extend into boxes 15 of the bottom row 13c. FIG. 3 provides further illustration of letter, number and sentence writing on the handwriting aid according to some embodiments. As illustrated in FIG. 3, numbers can be filled in vertically adjacent boxes 15 of the center 13b and top 13a rows.

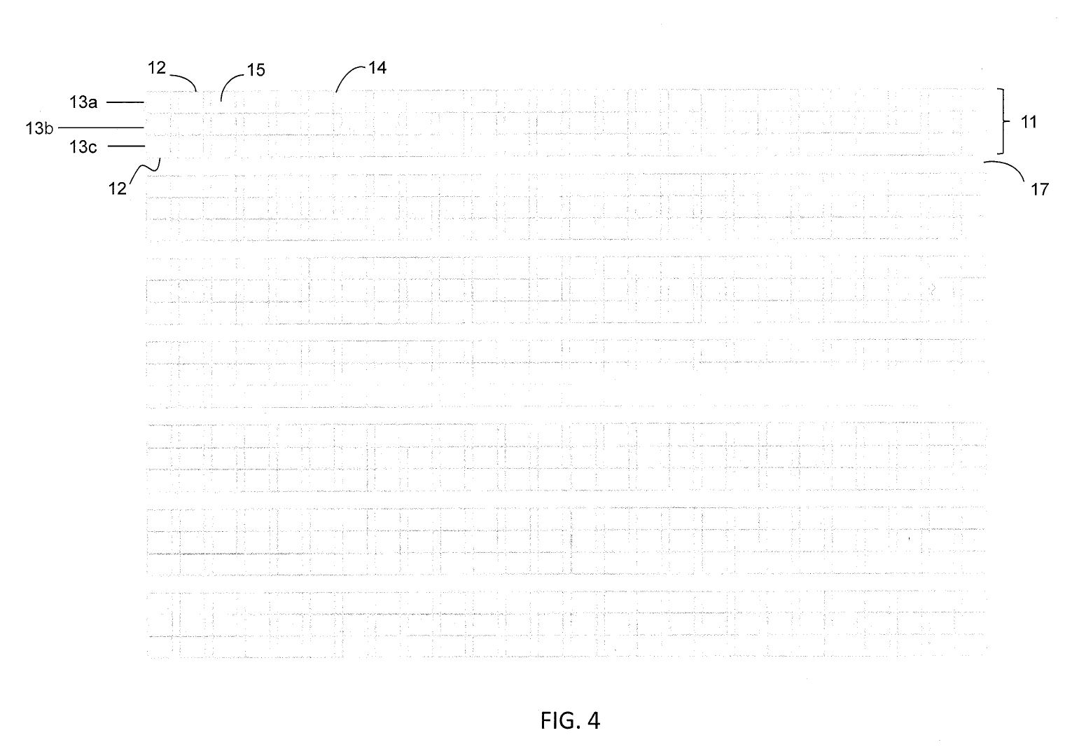

Referring now to FIG. 4, the dimensions of the writing bands 11 and associated features have decreased relative to those shown in FIG. 1. Decreasing band 11 size can be part of a handwriting system enabled by the handwriting aids 10 described herein. Writing bands 11 with larger dimensions can be used for younger students or beginners. As students become older or more experienced, they may graduate to writing bands having smaller dimensions. This can enable a smooth transition to writing on traditional ruled notebook paper. For example, writing bands 11 for older or more experienced students can be provided dimensions similar to traditional, ruled notebook paper, thereby facilitating the transition to the use of ruled notebook paper by the student. The writing bands may step down in dimensions in any desired number of increments. In some embodiments, the dimensional step down to ruled notebook paper occurs in 2 to 5 increments and can be based on age grouping of the student.

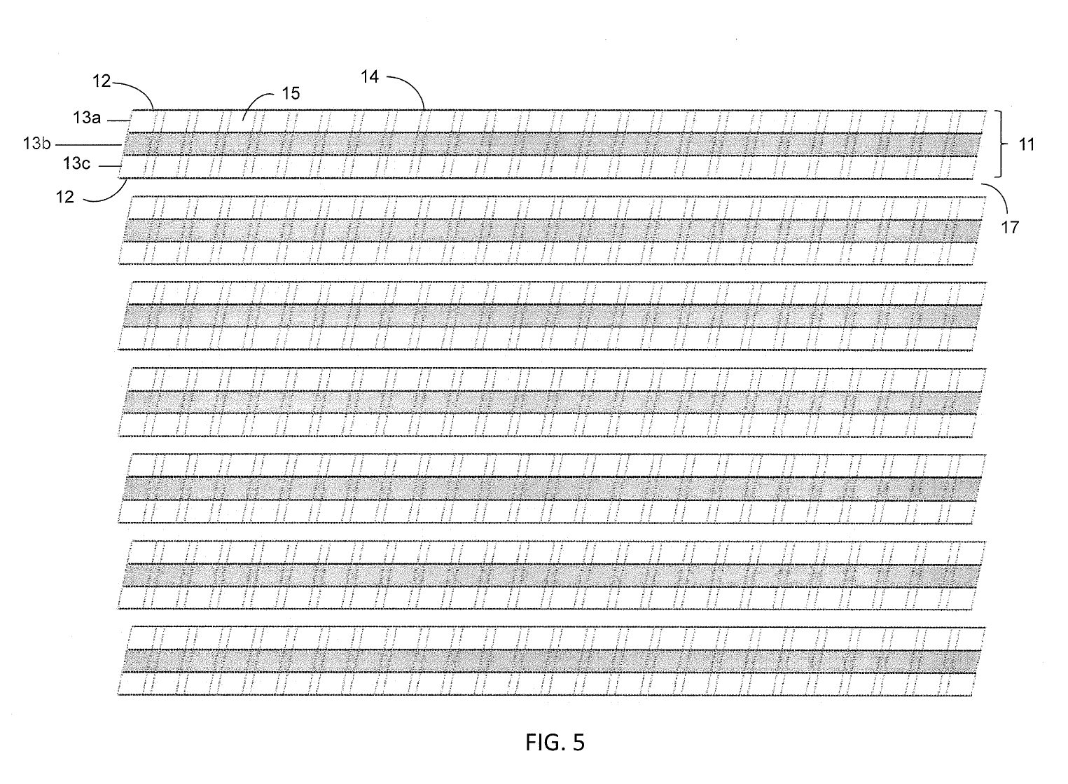

In the embodiments of FIGS. 1-4, the columns 14 are normal to the rows 13a-13c forming square boxes 15. As illustrated in FIG. 2, the square boxes 15 are suitable for printed upper case and lower case letters. In alternative embodiments, the columns are not normal to the rows. Referring to FIG. 5, the columns 14 are not normal to the rows 13a-13c and adopt a forward slant configuration. The non-normal positioning of the columns 14 forms parallelogram boxes 15. The parallelogram boxes are suitable for practicing cursive upper and lower case letters. Therefore, handwriting worksheets described herein find application to students of varying skill level for practicing print and cursive.

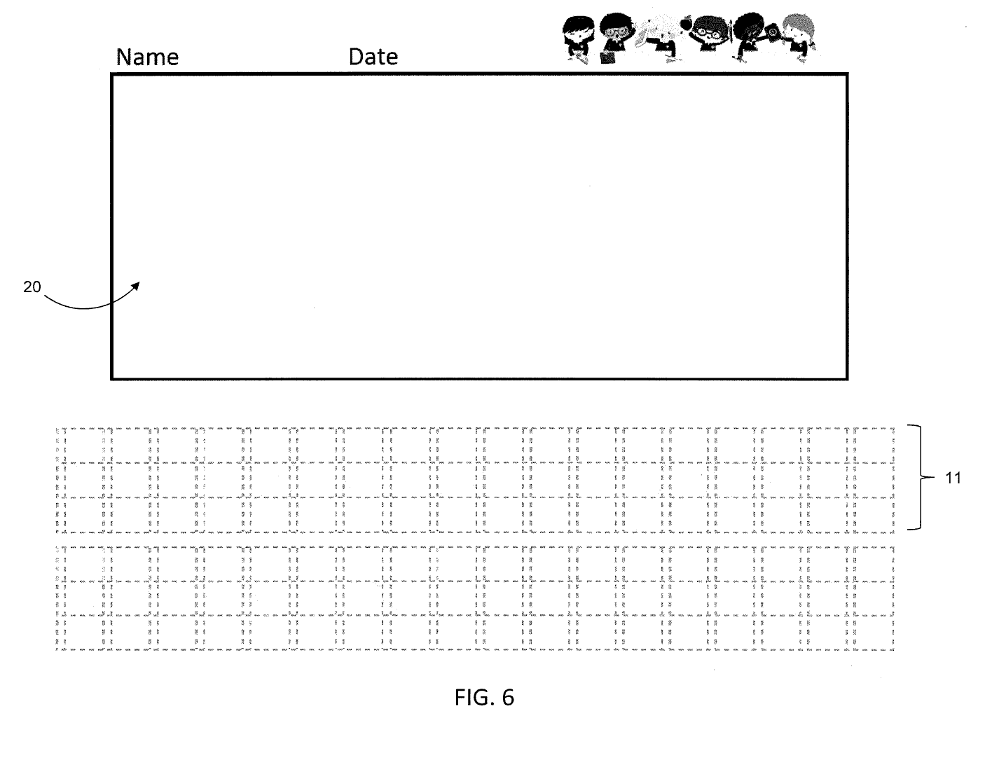

Referring now to FIG. 6, a handwriting aid described herein can include an open box in addition to the writing bands. In the embodiment of FIG. 6, an open box 20 is positioned above the writing bands 11. The open box 20 can have various functionalities. In some embodiments, users of the handwriting aid can draw pictures in the open box 20 and describe the pictures using the writing bands 11 below. For example, students may draw pictures of a story in the open box 20 and describe the story in the writing bands. Alternatively, text can be printed in the open box 20, and a user of the handwriting aid can write the text in the writing bands. In some embodiments, the teacher can add text to the box or students can cut out text and paste it in the open box 20 for copying in the writing bands 11.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. An aid for practicing handwriting comprising:
a medium having one or more writing bands marked thereon, a writing band including four horizontal lines defining three adjacent rows and columns dividing the three adjacent rows into blocks in which letters or portions thereof are to be written, wherein the columns have width less than width of the blocks and provide spacing between the letters.

2. The aid for practicing handwriting of claim 1, wherein the columns are of uniform width.

3. The aid for practicing handwriting of claim 1, wherein the vertical columns have uniform spacing providing the blocks uniform width.

4. The aid for practicing handwriting of claim 3, wherein the four horizontal lines have uniform spacing providing the blocks uniform height.

5. The aid for practicing handwriting of claim 1, wherein one or more of the adjacent rows has shading or texture.

6. The aid for practicing handwriting of claim 4, wherein a center row is shaded or textured differently than adjacent top and bottom rows.

7. The aid for practicing handwriting of claim 6, wherein blocks of the center row have dimensions in which a lower case letter body is written.

8. The aid for practicing handwriting of claim 7, wherein blocks of the top row have dimensions in which an ascender of a lower case letter is written.

9. The aid for practicing handwriting of claim 7, wherein blocks of the bottom row have dimensions in which a descender of a lower case letter is written.

10. The aid for practicing handwriting of claim 1, wherein blocks of a center row and adjacent top row provide space in which an upper case letter is written.

11. The aid for practicing handwriting of claim 1, wherein the columns are of non-uniform width.

12. The aid for practicing handwriting of claim 11, wherein a first set of columns have a first width for the spacing between the letters and a second set of columns have a second width for sentence spacing.

13. The aid for practicing handwriting of claim 1, wherein the columns are normal to the three adjacent rows.

14. The aid for practicing handwriting of claim 1, wherein the columns are not normal to the three adjacent rows.

15. The aid for practicing handwriting of claim 14, wherein the columns are slanted.

16. The aid for practicing handwriting of claim 1, wherein individual writing bands are separated on the paper by non-writing space.

17. The aid for practicing handwriting of claim 1, wherein dimensions of the three adjacent rows and blocks varies according to user age.

18. An aid for practicing handwriting comprising:
one or more writing bands marked thereon, a writing band including horizontal lines defining adjacent rows and columns dividing the adjacent rows into blocks in which letters or portions thereof are to be written, wherein the columns have width less than width of the blocks and provide spacing between the letters.

19. The air for practicing handwriting of claim 18, wherein the horizontal lines define two adjacent rows.

20. The aid for handwriting of claim 18, wherein the horizontal lines define three or more adjacent rows.
